(19) United States
(12) Patent Application Publication
(10) Pub. No.: US 2022/0250961 A1
(43) Pub. Date: Aug. 11, 2022

(54) METHOD AND APPARATUS FOR ADDITIVELY FORMING AN OPTICAL COMPONENT

(71) Applicants: Po-Han Huang, Solna (SE); Frank Niklaus, Täby (SE); Kristinn B. Gylfason, Solna (SE); Miku Laakso, Linköping (SE); Pierre Edinger, Stockholm (SE); Carlos Errando Herranz, Cambridge, MA (US); David Emmanuel Marschner, Stockholm (SE); Lee-Lun Lai, Solna (SE); BonSens AB, Lidingö (SE)

(72) Inventors: Po-Han Huang, Solna (SE); Göran Stemme, Lidingö (SE); Frank Niklaus, Täby (SE); Kristinn B. Gylfason, Solna (SE); Miku Laakso, Linköping (SE); Pierre Edinger, Stockholm (SE); Carlos Errando Herranz, Cambridge, MA (US); David Emmanuel Marschner, Stockholm (SE); Lee-Lun Lai, Solna (SE)

(21) Appl. No.: 17/171,587

(22) Filed: Feb. 9, 2021

(51) Int. Cl. C03B 19/01; B33Y 80/00; B33Y 10/00; B33Y 30/00

(52) U.S. Cl. CPC C03B 19/01; B33Y 80/00; H04N 13/254; B33Y 30/00; B33Y 10/00

(57) ABSTRACT

The present invention relates to a method for forming a 3D optical component comprising the steps of: forming over a substrate a liquid layer of a polymer in a solvent, drying said polymer for removing at least a portion of said solvent and thereby creating a layer having a first dissolution rate, exposing by multi-photon absorption using an electromagnetic radiation source a predefined volume of said layer, thereby causing the volume to have a second dissolution rate which is different to said first dissolution rate, dissolve the non-exposed areas with a liquid solution for forming the 3D optical component, wherein said polymer is Hydrogen silsesquioxane, HSQ, and said dried layer having a thickness of at least 1 μm.

### BACKGROUND

### Related Field

The present invention relates in general to the field of optical components. In particular, the present invention relates to methods for forming optical components for instance waveguides, filters, optical interconnects, lenses, diffraction gratings, etc., using multi-photon absorption.

### Related Art

Humankind has manufactured silica-glass objects for over three thousand years. Presently, silica glass is used in most branches of society, industry, and scientific research due to its excellent material properties: extreme thermal and chemical stability, excellent mechanical properties, and optical transparency in a wide wavelength range. However, the thermal and chemical stability of silica glass, together with its brittleness, impede its structuring, especially on a micrometric scale.

Known methods for manufacturing optical waveguides include, for instance, manually placing glass fibers into hollowed out areas on a substrate, filling a mold of a desired structure with a polymeric material that is thermally cured and later removed from the mold, and depositing an optical material on a substrate and patterning using reactive ion etching (RIE) processes. Each of these processes has drawbacks such as requiring multiple steps to define the waveguide, potential sidewall roughness issues, limited resolution, incompatibility with PWB manufacturing schemes and high labour costs.

Applying stereolithography to silica nanocomposites allows additive printing of silica-glass structures in 3D, but high-temperature sintering is necessary, and the minimum resolution is limited to about 60 micrometers which is still outside the relevant range for most microsystem applications. On the other hand, the subtractive method of laser-assisted chemical etching of a silica-glass volume enables fabricating 3D components with submicrometric features, but it suffers from the very limited capability of integration and rough surface.

There is a need in the art for micro-optical components and manufacturing method of the same with high resolution, improved dimension predictability and optical purity compared to known production methods.

### BRIEF SUMMARY

The present invention aims at obviating the aforementioned problem. A primary object of the present invention is to provide an improved method for forming a 3D optical component. Another object of the present invention is to provide an improved optical component manufactured according to above mentioned method. Yet another object of the invention is to provide a pattern generator configured for patterning a three-dimensional component in a layer of Hydrogen silsesquioxane.

According to the invention at least the primary object is attained by means of the system having the features defined in the independent claims. Preferred embodiments of the present invention are further defined in the dependent claims.

According to a first aspect of the present invention it is provided method for forming a three-dimensional component comprising the steps of: forming over a substrate a liquid layer of a compound in a solvent, drying said compound for removing at least a portion of said solvent and thereby creating a layer having a first dissolution rate, exposing by multi-photon absorption using an electromagnetic radiation source a predefined volume of said layer, thereby causing the volume to have a second dissolution rate which is different to said first dissolution rate, AND dissolving the non-exposed areas with a liquid solution for forming the three-dimensional component, wherein said compound is Hydrogen silsesquioxane, HSQ, and said dried layer having a thickness of at least 1 μm.

An advantage of this embodiment is that optical components with high precision and high dimension stability may be formed directly from a layer of HSQ. Another advantage is that the optical components as large as several hundreds of micrometers in all direction may be formed from said layer of HSQ. Yet another advantage is the complete freedom of manufacturing optical component with low optical attenuation.

In various example embodiments of the present invention said exposing of said predefined volume of said layer is made through said substrate which is at least partially transparent to the electromagnetic radiation.

An exemplary advantage of these embodiments is that a perfectly flat entrance surface of said HSQ layer is available for said electromagnetic radiation during exposure which may reduce any optical artifacts during printing.

In various example embodiment of the present invention said HSQ layer is formed by directing at least one droplet of HSQ in said solvent onto said substrate.

An exemplary advantage of these embodiments is that one or a plurality of drops may form a predetermined volume of HSQ for 3D printing.

In various example embodiments of the present invention the concentration of HSQ when forming said layer is at least 0.1 wt % but less than 80 wt % or 1-70 wt % or 5-60 wt %.

An exemplary advantage of these embodiments is that various concentrations of HSQ may be used during layer formation. The higher the concentration of HSQ the less the number of droplets or repeating of deposition is needed, the shorter the preparation time and the sooner the layer is ready for exposure. However, a high concentration of HSQ, close to saturation level, may complicate the HSQ layer formation process as the viscosity may complicate a depositing process and layer formation (like HSQ being stuck at the pipette head and/or drying very slowly) and/or increase the layer formation time.

In various example embodiments of the present invention said method further comprising a baking step wherein said 3D optical component is heated to a temperature above 800° C. for a predetermined period of time for transforming the exposed HSQ into silica glass. In various example embodiments of the present invention said 3D optical component is heated to a temperature above 850° C. or 900° C. for a predetermined period of time for transforming the exposed HSQ into silica glass

An exemplary advantage of these embodiments is that high purity silica glass optical components may be manufactured additively in a cost effective and simple manner.

In various example embodiments of the present invention the exposed volume of HSQ fully encloses a non-exposed volume of HSQ, which non-exposed volume of HSQ after baking becomes photoluminescent.

In another aspect of the present invention it is provided pattern generator configured for patterning a three-dimensional component in a layer having a thickness of at least 1 μm of Hydrogen silsesquioxane, HSQ, said pattern generator comprising: at least one tunable pulsed laser source with a pulse duration less than 1 nanosecond, means for moving a target layer relative to a focus of said pulsed laser source for generating a defined path for patterning said three-dimensional component, an image capturing system for recording the patterning of said three-dimensional component, an image analyzing program for detecting in said recorded images at least one of presence of light, intensity of light, delay of light generation, wavelength of light, and/or the visual difference between a patterned and a non-patterned area, and a control unit for controlling said tunable pulsed laser source and said means for moving said target layer relative to said focus of said pulsed laser source, said control is configured for varying at least one of power of said tunable laser source, frequency of said tunable laser source, and/or speed of said means for moving said target layer relative to said focus of said pulsed laser source based on at least one parameter from said image analyzing program.

An exemplary advantage of this embodiment is that the final result of the 3-dimensional object in HSQ may be monitored and thereby tailorized after customer needs such as manufacturing speed and end result quality.

An exemplary advantage of these embodiments is that the additive manufacturing process enables formation of photoluminescent optical components having almost any shape.

Further exemplary advantages with and features of the invention will be apparent from the following detailed description of preferred embodiments.

### BRIEF DESCRIPTION OF THE FIGURES

A more complete understanding of the abovementioned and other features and advantages of the present invention will be apparent from the following detailed description of preferred embodiments in conjunction with the appended drawings, wherein:

FIG. 1a-b depict schematic pictures of an exposure system and multi-photon absorption principle,

FIGS. 2a-e depict various method steps according to the present invention, and

FIG. 3 depicts an optical component manufactured with the inventive method.

### DETAILED DESCRIPTION OF VARIOUS EMBODIMENTS

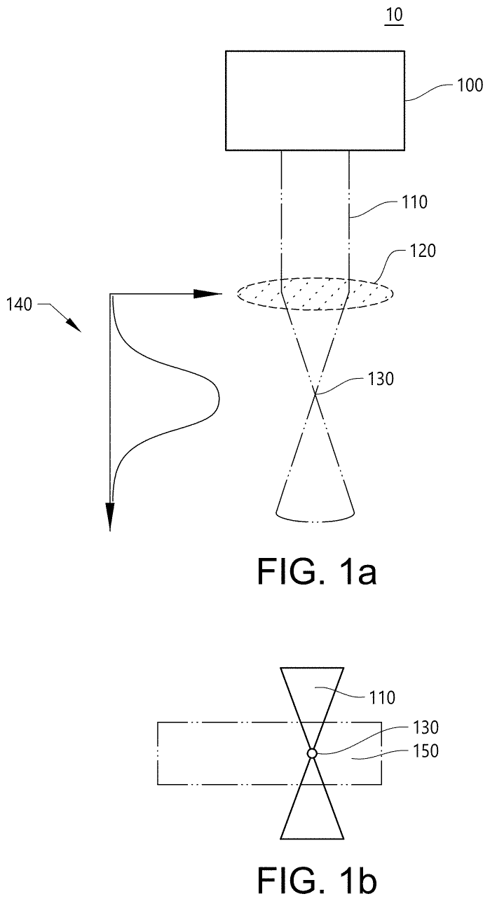

FIGS. 1a-b depicts a schematic picture of an exposure system 10 and multi-photon absorption principle. The exposure system 10 comprises a source for generating electromagnetic waves 100, a focusing lens 120 and a photo imageable layer 150. The source for generating electromagnetic waves may be a light source, for instance a femtosecond titanium sapphire laser, an argon ion-pumped laser, a colliding-pulse mode locked laser operating at frequencies from 1 Hz-100 MHz or 10 Hz-80 MHz or 100 Hz-1 MHz. The focusing lens 120 may be a single lens or a lens system. The focusing lend may be immersed in immersion oil for improved optical performance. The lens system may have fixed lenses in relation to each other or lenses with adjustable distance from each other. The lens system may be a variable focal-length lens assembly. The lens system may provide for a varying position of a focal point 130 within said photo imageable layer 150 in one or several directions. In various example embodiments the focal point is variable in a direction perpendicular to a top surface of said photo imageable layer 150, i.e., in Z-direction. The position of said focal point in x-y direction may in such case be performed by varying the position of the photo imageable layer 150 and/or the position of the source for generating electromagnetic waves 100 and objective lens 120. In various example embodiments the position of the photo imageable layer 150 is fixed and the source for generating electromagnetic waves 100 is fixed wherein the relative position of the focal point is varied in x-y-z direction within the photo imageable layer 150 is performed by the focusing lens alone. In various example embodiments an X-Y-Z stage moves around a focal point of the electromagnetic radiation in said volume of HSQ. In FIG. 1a only one source for generating electromagnetic waves 100 is shown, in various example embodiments two or more sources for generating electromagnetic waves 100 may be used in combination. Multiphoton absorption occurs in the vicinity of the focal point 150, i.e., there is a distinct on-off state between exposed and non-exposed areas. FIG. 1a illustrates in the diagram 140 that the photon density is highest on the focal point 130. By varying the position of the focal point, a predefined volume 130 of the photo imageable layer 150 may be exposed and thereby a 3D optical component may be formed within said photo imageable layer 150.

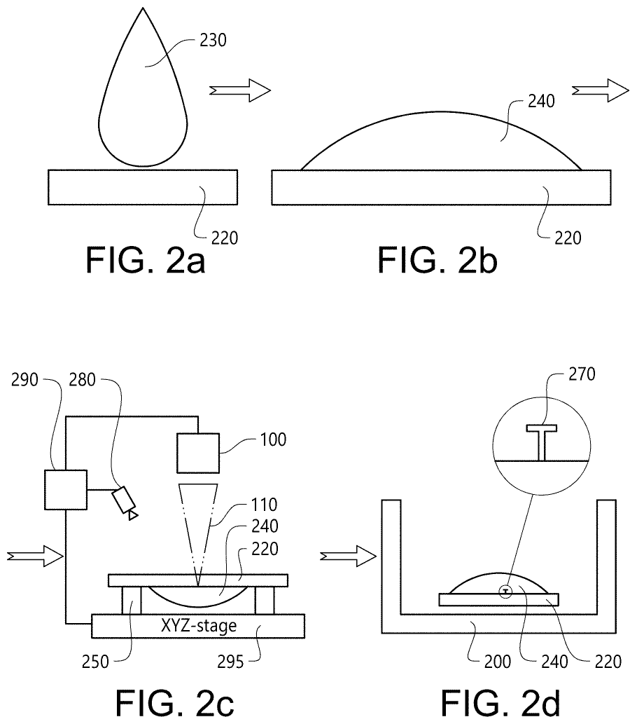

FIG. 2a depicts a first step of the inventive manufacturing method for manufacturing 3D optical component. In the first step a layer of photo imageable component is formed on top of a substrate 220. The substrate may be a flat substrate or a substrate with a structure. A structured substrate may be shaped so as to receive said HSQ in defined volumes. Dissolved HSQ may be drop-casted on a silica-glass substrate 220 until a predetermined thickness has been achieved. One or several drops 230 of HSQ are applied onto the substrate 220 for forming a sufficiently thick layer of HSQ. The solvent may be an organic solvent such as MIBK (Methyl Isobutyl Ketone), however various other organic solvents may be used such as Toluene, IPA, ethyl acetate and Acetone. A fused-silica glass substrate (JGS2 optical-grade fused quartz, MicroChemicals) with a thickness of 250 μm may be used as a substrate 220. Any substrate suitable for supporting a photoimageable layer and an optical component formed in the layer may be used. Suitable substrates include, but are not limited to, substrates used in the manufacture of electronic devices such as printed wiring boards and integrated circuits. Suitable substrates may be laminate surfaces and metal surfaces of metal clad cards, printed wiring board inner layers and outer layers, polymer substrates and polymer fibers, wafers used in the manufacture of integrated circuits such as silicon, III-V semiconductors, gallium arsenide, and indium phosphide wafers, glass substrates including but not limited to liquid crystal display (LCD), glass substrates, dielectric coatings, silicon oxides, silicon nitrides, silicon oxynitrides, sapphires, epoxy laminates, polyimides, polysiloxanes, cladding layers, tip of an optical fiber, a cavity in an optical fiber, a thin film flexible PMMA, a silica substrate, a phosphide substrate and the like. The metal in metal clad cars and metal surfaces may be copper, silver or the like. The substrate 220 is optically transmissive in the wavelength range between 270 nm and 2 μm and has a typical hydroxyl (OH) concentration below 300 parts per million. The substrate may before use be cleaned by rinsing first with acetone and then isopropanol, followed by drying in air. HSQ in methyl-isobutyl-ketone-based solution (FOX16, Dow Corning) may be drop-casted on the substrate 220. The thickness of the HSQ layer 240 may be grown to a thickness of about 100 μm by drop-casting multiple times on the same location while allowing a few minutes for drying of the HSQ in air at room temperature between the casts. In various example embodiments the concentration of HSQ when forming said layer is at least 0.1 wt % but less than 80 wt %. In various example embodiments the concentration of HSQ when forming said layer is at least 1 wt % but less than 70 wt %. In various example embodiments the concentration of HSQ is higher than 30 wt % but less than 50 wt % when forming said layer. A high concentration of HSQ will simplify achieving high enough thickness for 3D printing.

After drop-casting, the sample may be left to dry in a fume hood at room temperature for about 12 hours. Drying may also be performed in vacuum and soft baking at below 220° C. After drying, the HSQ layer 240 on the fused-silica glass substrate 220 had a hard texture FIG. 2b. The dried layer may have a thickness of at least 1 μm.

Once the solvents had evaporated a laser beam 110 from a laser source 100 was used to trace the desired 3D shape in the dry HSQ through the transparent substrate 220. The substrate 220 may be at least partially transparent for the wavelength used for exposure if exposure is to be made through said substrate 220. In case the exposure is not via the substrate 220 but directly onto said layer of HSQ 240, said substrate 220 may be made of any suitable material for the full manufacturing process. In FIG. 2c the substrate 220 is arranged up-side down on support structure elements 250. The support structure elements may comprise holding means for said substrate in the form of clamping means and/or suction means. In FIG. 2c the dried HSQ on glass substrate 220 may be exposed by using a sub-picosecond laser (Spirit 1040-4-SHG, Spectra-Physics of Newport Corporation) operating at a central wavelength of 1040 nm, a repetition rate of 10 kHz, and a pulse duration of 298 fs. The laser beam 110 may, as depicted in FIG. 2c, be focused through the glass substrate 220 inside the HSQ using an objective with a numerical aperture of 0.65 (Olympus Plan Achromat RMS40X). Suitable laser powers for exposure may be found by observing the appearance of the patterned structures through the objective using a camera 280. The single-pulse energies used in the patterning may be between 0.1-50 nJ or between 7 nJ and 20 nJ or between 14 nJ and 18 nJ, measured with a silicon optical power detector (918D-SL-OD3R, Newport) after the pulses exited the final focusing objective of the laser system. In various example embodiments said electromagnetic radiation 110 for exposure may be at least one laser source 100 having a pulse duration shorter than a nanosecond or a pulse duration shorter than 100 picoseconds or a pulse duration shorter than 1 picosecond and having a wavelength above 157 nm or above 314 nm or between 157 nm-2500 nm. The glass substrate 220 with the dried layer of HSQ 240 may be moved by a 3-axis linear motorized stage 295 (XMS100, Newport) and the movement speed during printing was typically between 0.5 μm/s and 1 μm/s. In various example embodiment the exposure of the HSQ is made directly onto said layer of HSQ 240 instead of via the substrate 220 as depicted in FIG. 2c. The exposure of HSQ will change its dissolution rate compared to non-exposed areas thereby enabling a removal of non-exposed areas after final exposure. In various example embodiments the energy of a single exposure pulse is below 20 nJ, the printing speed to be below 1 μm/s, and the exposure pulse frequency to be below 20 kHz. A control unit 290 may control the motorized stage 295, an image capturing system 280 and the source for generating electromagnetic sources 100.

The image capturing system 280 may be used for recording the patterning process. The image capturing system may be a light sensing unit such as a camera. An image analyzing program may be used for detecting in said recorded images or sensed signals at least one of presence of light, intensity of light, delay of light generation, wavelength of light, and/or the visual difference between a patterned and a non-patterned area. The control unit 290 may be used for controlling said source for generating electromagnetic sources 100, which source may be a tunable pulsed laser source, and said motorized stage 295 for optimizing at least one of power of said tunable pulsed laser source, frequency of said tunable pulsed laser source, polarization of said tunable laser source and/or speed of said motorized stage 295 based on at least one parameter from said image analyzing program. Said control unit may comprise said analyzing program. Said motorized stage 295 may comprise holding means for a target layer. The holding means may secure the target layer relative to the motorized stage 295 so that a predetermined movement of the motorized stage 295 results in the same predetermined movement of said target layer. The target layer may be the applied volume of HSQ 240 onto said substrate 220. A tunable pulsed laser source may for instance be a Nd:YAG pumped type II BBO OPO laser from Litron Lasers.

The HSQ on the glass substrate that was not exposed to the laser light may be removed in a development step as depicted in FIG. 2d. The development may be done by immersing the sample in a 0.1 M solution of potassium hydroxide (Sigma-Aldrich) in de-ionized water. The development may be performed by providing said substrate with exposed layer of HSQ into a container 200 containing said development solution. To this mixture, 0.05 vol % of Triton X-100 (LabChem Inc.) may be added as a surfactant to decrease the size of bubbles formed in the development process and thus to reduce the damage caused by bubbles to the 3D printed micro-structures. The development may be done of at least 8 hours and thereafter the sample may be rinsed with de-ionized water. In FIG. 2e the finished three-dimensional component 270 may be left to dry in air at room temperature. Finished three-dimensional components 270 may also be dried using critical point drying to prevent breaking of the structures by surface tension. Optical and electron microscopy revealed that the printed three-dimensional component 270 were formed as designed and featured smooth sidewalls. The smallest lateral width that still allowed structures that did not collapse during development was approximately 0.2 μm while the minimum height of these structures was approximately 0.5 μm. This difference between the width and height is a well-known effect in 3D direct laser writing, and it has been attributed to the 3D shape of the laser focus (i.e., voxel), which is extended in the direction of the laser propagation. Increasing the single-pulse energy of a laser may strengthen this effect. In various example embodiments a submicrometric voxel height by reducing the single-pulse energy of our laser. Non-exposed HSQ is empirically HSiO_{1.5}, intermediate species could be anything between HSiO_{1.5} and HSiO₂, and the baked material is silica SiO₂.

In an optional step baking at different temperatures may be done in an oven with an air, N₂ or O₂ atmosphere. Printed three-dimensional components 270 may be placed inside the oven at room-temperature, after which the oven was heated to the baking temperature. The temperatures are the measured air temperature inside the oven. The heating of the oven from room temperature to 1200° C. may take a few hours. The oven may be kept at the desired baking temperature for one hour after which the oven was powered off and left to cool down naturally for about four hours. The three-dimensional component 270 may not be removed from the oven before the temperature had decreased to below 150° C. After baking the exposed three-dimensional component 270 has been transformed to fused silica. To evaluate whether the printed material can be classified as silica glass after baking, we used energy-dispersive X-ray spectroscopy (EDS) to measure its elemental composition and electron diffraction to investigate its crystallinity. EDS data collected from the bulk of the as-printed material showed silicon and oxygen along with an atomic concentration of carbon below one percent. The electron diffraction pattern showed that the printed material was amorphous (i.e., glass). Together, these results confirmed that the printed material was silica glass. In various example embodiments the exposed volume of HSQ fully encloses a non-exposed volume of HSQ, which non-exposed volume of HSQ after baking may have a different morphology compared to the exposed volume and where said non-exposed volume may become photoluminescent. In various example embodiments a photoluminescent micro-structures encapsulated by silica glass may be achieved by curing a shell with the wanted shape in which non-lasered HSQ is encapsulated.

After development and high temperature baking, the non-lasered part becomes photoluminescent, while the laser-cured shell turns to silica glass. Non-porosity and homogeneity of the printed silica glass are key properties for applications because they allow printing of transparent, hermetic material of consistent quality. We investigated porosity and homogeneity by cutting through printed structures using focused ion beam (FIB) milling and inspecting the cross-sections using transmission electron microscopy (TEM) and scanning electron microscopy (SEM). The material was free of internal pores down to the size of a few nano-meters, which was the lower limit observable using TEM. These experiments also revealed the material to be homogenous, except for a low concentration of inhomogeneities with the size of a few nano-meters, visible in high-resolution TEM images. The chemical bonds in the as-printed silica glass may be investigated using Raman spectroscopy. It showed three different categories of features that are abnormal for the Raman spectrum of a commercial silica-glass substrate. The categories of the features are residual carbon species, hydrogen related species, and 3- and 4-membered rings in a silica-glass network. Since HSQ itself does not contain carbon, we hypothesize that the residual carbon species originated from the organic solvents in the HSQ solution that might not have entirely evaporated from the drop casted HSQ before laser patterning. The hydrogen related species included Si—H bonds, hydroxyl groups (OH), and molecular water. The presence of Si—H indicates incomplete cross-linking of HSQ.

The hydroxyl groups and the molecular water are often found in silica glasses with high water content. The 3- and 4-membered rings have been linked to an increased fictive temperature, density, and refractive index of silica glass, which can be a result of rapid temperature changes caused by laser processing. To investigate whether baking of printed silica glass would remove the imperfections discussed above, we collected Raman spectra from 3D-printed structures baked at temperatures of 150° C., 300° C., 500° C., 800° C., and 900° C. The Si—H Raman signal disappeared already after baking at 150° C. The carbon species, molecular water, and hydroxyl groups were completely removed when the structures had been baked at 800-900° C. The samples baked at temperatures from 150° C. up to 800° C. developed a photoluminescent background signal in their Raman spectra. We characterized the photoluminescence by collecting a complete photoluminescent spectrum from the sample baked at 500° C. This spectrum revealed that the photoluminescent background is a part of a broad photoluminescent peak slightly above 2 eV with a long tail at higher energies. Photoluminescence around these energies can originate from at least three different types of defects caused by laser exposure of silica glass. These defects are non-bridging oxygen hole centres with and without hydrogen bonding respectively causing photoluminescence peaks at 2.0 eV and 1.9 eV, a silicon cluster at 2.2 eV, and an oxygen-deficiency centre at 2.7 eV, where the last one means a direct silicon-silicon bond in a silica-glass network. The photoluminescence was removed and the signal from 3- and 4-membered rings was reduced to normal levels after baking at 800-900° C. It can be concluded from the Raman spectroscopy experiments above that baking at 800-900° C. removes all the abnormal chemical bonds in the printed silica glass on a level matching that of commercial silica glass.

Our material characterization results demonstrated that we can directly 3D-print nonporous silica-glass structures without the need for high-temperature baking, while for obtaining silica glass that matches in quality the commercial substrate material, the 3D-printed structures need to be baked at 900° C. Baking at high temperatures have been reported to cause shrinkage of 3D-printed structures, which can distort the geometry of structures that are attached to a substrate at multiple points. We wanted to confirm that the very low carbon content and the lack of pores in our laser-printed silica glass results in a decreased shrinkage in comparison to other 3D-printing methods. We evaluated the shrinkage of our laser-printed silica glass by printing five T-shaped structures followed by measuring the lengths of the horizontal beams of the T-shaped structures before and after baking at different temperatures. The mean values of the relative length decrease of the five beams from their original lengths gave us the relative linear shrinkages. Baking at 900° C. caused a shrinkage of only (6.1±0.8)%, which compares favourably to the much larger shrinkages, between 16% and 56%, of materials reported for other 3D printing methods. The low shrinkage of our 3D-printed structures decreases the risk of geometric distortions during baking, as demonstrated by the structures that survived baking at temperatures of up to 1200° C.

Some of the most interesting application fields of micro 3D-printed silica glass are in photonics and micro-optics, where the excellent optical transmission of silica glass makes it the material of choice. To demonstrate the transparency of micro 3D-printed silica glass, we printed a structure consisting of a ring directly on substrate's surface and a suspended, about between 2.5 μm and 3 μm thick, plate above the ring. We used an optical microscope to image the ring through the suspended plate, both directly after the development of the structure and after baking the structure at temperatures of 900° C. and 1200° C. The suspended plate was transparent in all the cases. Baking at 1200° C. caused smoothening of the 3D-printed features and improved the optical quality of the plate, resulting in even sharper optical-microscope images of the ring. The smoothening can be continued by extending the baking time at 1200° C., which we demonstrated by baking the same structure for a second time at a temperature of 1200° C. The glass-transition temperature of silica glass is 1200° C., which is consistent with the changes we observed at this temperature. Even though baking at 1200° C. is unnecessary to obtain pure silica glass, it can be used to smoothen the surfaces of the 3D printed glass, albeit control over the structural shape can be reduced to some extent. This type of smoothening can for example be useful for improving the optical quality of 3D printed components 270.

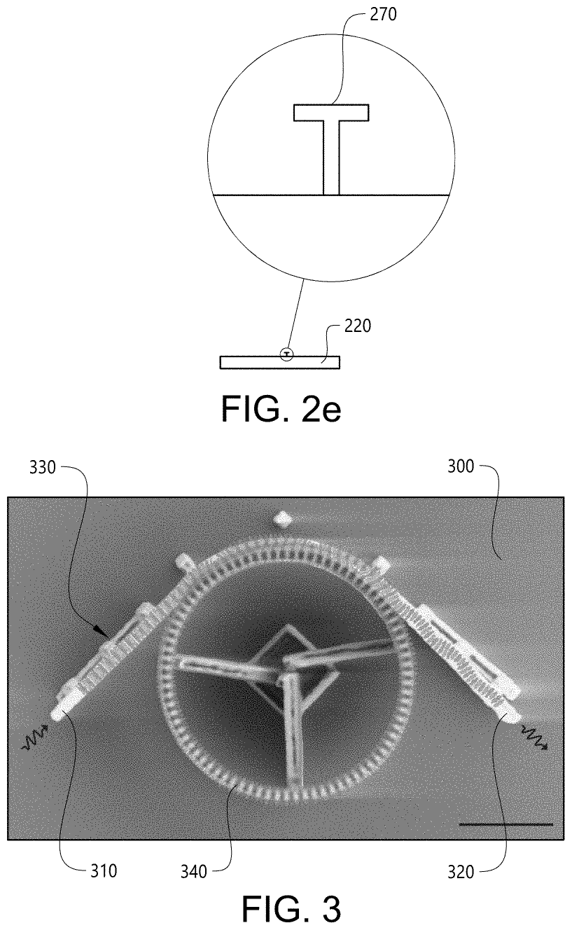

To demonstrate the utility of our 3D printing approach for realizing functional microdevices in general, and photonic systems in particular, we have 3D printed and characterized an integrated optical microtoroid resonator 300 FIG. 3. The resonator 300 comprises a bus waveguide 330, an inlet 310 for light and an outlet 320 for light and a motoroid resonator section 340, all made of fused silica. The geometric design freedom of the 3D printing process allowed us to print the bus waveguide slanted upwards from the substrate plane, which enabled convenient out-of-plane coupling of light between the ends of the waveguide and optical fibers. Furthermore, the 3D printing enabled us to suspend the entire system at least 3 μm above the substrate surface, thus preventing optical coupling of the light into the substrate. The waveguide dimensions and the microtoroid radius were chosen based on simulated behaviour of the system. According to the simulations, the waveguide supports three transverse electric (TE) and three transverse magnetic (TM) modes. The resonator performance was characterized by measuring its transmission spectrum in the optical telecommunication bands between 1450 nm and 1580 nm. The transmission was measured using vertical and horizontal linear polarizations of the input light. When suitable coupling conditions were used, these polarizations mainly excited the fundamental quasi-transverse magnetic mode (TM₀₀) or the fundamental quasi-transverse electric mode (TE₀₀) in the bus waveguide. The transmission was first measured for the as-printed resonator and then again after baking at 150° C., 300° C., and 900° C. For both fundamental modes and all the cases of baking and the lack thereof, the transmission spectra showed a clear set of resonances, thus confirming the functionality of the resonator. The collected resonance spectra were fitted with an analytical single-mode resonator model that we used to extract the free spectral range, FSR, and the quality factor of the resonator. The obtained FSRs were close to the value of 16 nm, which is the FSR we expected for the resonator based on its radius and the simulated group indexes of the silica glass. The FSR of the resonator trended slightly upwards as baking temperature was increased. We attribute this trend to the shrinkage of the silica glass, which reduces the resonator radius. Baking at 900° C. causes a shrinkage of approximately 6%, which should increase the FSR from 16 nm to 17 nm, which is in scale with the FSR change we observed. Additionally, a change of the group index of the silica glass during baking can also have contributed to the increased FSR. The spectrally averaged quality factor derived from a complete transmission spectrum of the resonator did not show trends over the different baking temperatures. We expect the quality factor to be dominated by the bend and anchor losses and not by a possible change in material absorption due to baking. Overall, the resonator performance is stable over the baking temperatures, which confirms that the 3D-printed silica glass can be used for photonic and optical microdevices, both with and without a baking step following the 3D printing.

3D printing technology may make it possible to additively manufacture 3D silica-glass structures with sub-micrometer features on a substrate surface. These capabilities are going well beyond the capabilities of existing surface micromachining techniques, including those that utilize growth, deposition, lithography, etching, and lift-off of silica-glass layers and those that use direct cross-linking of HSQ via linear absorption of electrons or deep UV light. The existing techniques are capable of manufacturing only two dimensional (2D) structures, with limited 2.5D features possible by using sacrificial structures as scaffolding to support the deposited silica glass. In contrast to forming empty 3D volumes inside a silica-glass substrate which has been shown using bulk micromachining methods such as molding and laser-defined wet etching, our method allows integrating 3D silica-glass structures onto substrates that already contain pre-manufactured microstructures using lithography-based methods. In addition to printing on various types of pre-processed substrates, additive manufacturing could also allow the microstructures to be placed at the tip of optical fibers or to be released into a fluidic medium to act as microrobots. Furthermore, the chemical and thermal stability of printed silica glass allow coating 3D-printed structures with metals or other materials, thus tailoring the properties of the final 3D structure. These properties could also be modified by mixing functional materials into HSQ before printing. For example, introducing nano-diamonds would enable hybrid quantum photonics integration and adding ferrous nanoparticles could achieve magnetically remote motion control of the printed structures. In situations where commercial-grade silica glass is required but the substrate or other microstructures in the same microsystem do not tolerate the 900° C. baking temperature, the printed silica glass could still be locally heat treated by laser annealing.

Additive 3D printing of silica glass, together with the wide range of promising extensions to the technology, may find applications in fields such as photonics, quantum optics, nano-mechanics, robotics, cell biology, chemistry, and medicine. For these fields, the 3D-printed microstructures are on the right scale to interact with light, fluids, and cells. Simultaneously the related applications will benefit from the superior material properties of silica glass such as its chemical inertness, hardness, and excellent optical properties. Vitally, our technology opens a completely new, 3D design and manufacturing paradigm for these fields, which all hold great promise for future research.

Photoluminescence sources, in contrast to the laser-induced defects discussed above, can also be intentionally embedded in HSQ, by generating silicon nanocrystals using high-temperature baking of non-laser-exposed HSQ. Thus, by combining laser patterning and baking, our 3D printing process enables selective functionalization of the 3D-printed structures for luminescence applications. We demonstrated this by printing two cubes on a substrate, one of which was a laser-exposed shell encapsulating a core of unexposed HSQ, while the other had its whole volume laser exposed. After baking of the cubes at 1,200° C. in air, a strong photoluminescence peak centered at a wavelength of 670 nm (1.85 eV) was observed in the volume of the unexposed HSQ, indicating the presence of silicon nanocrystals, while the laser-exposed shell, as well as the fully laser-exposed cube, showed little to no photoluminescence. In addition to the full freedom of embedding silicon nanocrystals inside printed silica-glass structures in 3D, the properties of silicon nanocrystals are also tuneable by manipulating baking parameters. This protocol paves a new way towards applications that utilize silicon nanocrystals, including light-emitting devices, nonlinear optics, photovoltaic cells, and sensors.

Silica glass is an extremely important structural and functional material in modern society. It may be used for buildings and vehicles; laboratory, culinary, and decorative glassware; and for optical lenses and fibers in photography, medicine and telecommunications. The inventive 3D printing process of optically transparent silica-glass structures, with submicrometric features, on a substrate takes advantage of our finding that hydrogen silsesquioxane (HSQ), with the empirical formula HSiO_{1.5}, can be selectively cross-linked in 3D via exposure to sub-picosecond laser pulses. At a near-infrared wavelength of 1040 nm, the laser light is not linearly absorbed by HSQ, while the sub-picosecond pulse duration allows nonlinear absorption in the focal volume of the laser. Importantly, the 3D-printing process does not rely on organic compounds, acting as photoactivated binders, whose removal would require a high-temperature baking step that would result to distortive shrinkage. Instead, HSQ is directly cross-linked to silica glass by the laser.

In the hereinabove embodiments, a so called “high-resolution mode”, no light is present during the whole patterning process. To achieve this high-resolution mode, the working parameters may be 1 kHz to 1 MHz electromagnetic wave pulse rate, an electromagnetic wave pulse energy between 0.1 nJ to 50 nJ, and a motorized stage 295 speed below 1 μm/s. The smallest resolution may be sub 500 nm, printed structures may have smooth surface. The manufacturing speed of the three-dimensional component is relatively low. Light during the patterning process may be captured by said camera 280. The light may be generated during the patterning process in all directions but can have slight preference in certain directions. The observed light during patterning may have the same or a different wavelength than the wavelength of the laser source used for patterning. To analyze the presence of light, intensity of light, delay of light generation, and/or the visual difference between a patterned and a non-patterned area, normal image analysis software with time stamps on the captured images may be used such as ImageJ or microscope softwares. A filter and/or a motorized polarizer may be used for analyzing the wavelength and/or polarization of the and the light created during the patterning process. The status of the filter/polarizer may be stored with each captured image.

In an alternative embodiment, a so called “fast mode”, light is present during at least a portion of the manufacturing process with different intensity, delay, or wavelength, which can be related to the quality of printed structure. Baking of these structures at above 1000/1100/1200° C. may smoothen the outer surface of the three-dimensional component. This fast mode is easy to achieve by, having a pulse energy higher than 50 nJ with any combination of speed of the motorized stage 295 and a pulse rate of the electromagnetic wave so that the separation between pulses is smaller than 1/0.5/0.3 μm. The fast mode may also be achieved by a pulse energy of the electromagnetic wave in between 0.1 nJ and 50 nJ, a pulse separation of the electromagnetic wave being larger than 0.01/0.05/0.1 nm and a speed of the motorized stage 295 which is smaller than 1000 μm/s. The minimum voxel may be about 1.5 μm in height and 0.5 μm in width and the printed structures may have a relatively rough outer surface. The manufacturing speed of the three-dimensional component is relatively high or at least faster than the high-resolution mode. In an example embodiment the exposed volume is within 1-1000 μm³. In various example embodiments of the present invention said exposed volume may be within 0.1-100000 μm³, or 0.1-50000 μm³, or 0.1-10000 μm³.

### MODIFICATIONS AND CONCLUSION

The invention is not limited only to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

Throughout this specification and the claims which follows, single dependency is recited according to local practice. It should be understood, though, that any of the dependent claims may dependent from any combination of any preceding claim, according to the embodiments described above and shown in the drawings.

1. A method for forming a three-dimensional component comprising the steps of:
forming over a substrate a liquid layer of a compound in a solvent,
drying said compound for removing at least a portion of said solvent and thereby creating a layer having a first dissolution rate,
exposing by multi-photon absorption using an electromagnetic radiation source a predefined volume of said layer, thereby causing the volume to have a second dissolution rate which is different to said first dissolution rate, and
dissolving the non-exposed areas with a liquid solution for forming the three-dimensional component, wherein said compound is Hydrogen silsesquioxane, HSQ, and said dried layer having a thickness of at least 1 μm.

2. The method according to claim 1, wherein said exposing of said predefined volume of said layer is made through said substrate which is at least partially transparent to the electromagnetic radiation.

3. The method according to claim 1, wherein said layer is formed by directing at least one droplet of said compound in said solvent onto said substrate.

4. The method according to claim 1, wherein the concentration of HSQ when forming said layer is at least 0.1 wt % but less than 80 wt %.

5. The method according to claim 1, wherein said electromagnetic radiation is at least one pulsed laser source having a wavelength above 157 nm.

6. The method according to claim 5, wherein said pulsed laser source having pulses shorter than one nanosecond.

7. The method according to claim 1, further comprising a baking step wherein said 3D optical component is heated to a temperature above 800° C. for a predetermined period of time for transforming the exposed HSQ into silica glass.

8. The method according to claim 7, wherein the non-exposed volume after baking having a different morphology compared to the exposed volume.

9. The method according to claim 8, wherein the exposed volume fully encloses a non-exposed volume, in which the non-exposed volume after baking becomes at least one of photoluminescent or electroluminescent.

10. The method according to claim 1, wherein the size of exposed features in a direction perpendicular to a surface of said substrate is at least 500 nm.

11. The method according to claim 1, wherein said substrate is a tip or cavity of an optical fiber, a polymer film, a silicon substrate, silica substrate, a III-V semiconductor substrate and/or a metal substrate.

12. The method according to claim 1, wherein said solvent is an organic solvent.

13. A three-dimensional component manufactured by the method according to claim 1.

14. The three-dimensional component according to claim 13, wherein the three-dimensional component is an optical resonator, waveguide, grating, filter, compact lens, or a phase shifter.

15. The three-dimensional component according to claim 13, wherein said three-dimensional component having a chemical formula between SiO_{1.5} to SiO₂ is attached to a substrate, said three-dimensional optical component has a smallest feature size below 10 μm in z-direction.

16. A pattern generator configured for patterning a three-dimensional component in a layer having a thickness of at least 1 μm of Hydrogen silsesquioxane, HSQ, said pattern generator comprising:
at least one tunable pulsed laser source with a pulse duration less than 1 nanosecond,
means for moving a target layer relative to a focus of said pulsed laser source for generating a defined path for patterning said three-dimensional component,
an image capturing system for recording the patterning of said three-dimensional component,
an image analyzing program for detecting in said recorded images at least one of presence of light, intensity of light, delay of light generation, wavelength of light, and/or the visual difference between a patterned and a non-patterned area, and
a control unit for controlling said tunable pulsed laser source and said means for moving said target layer relative to said focus of said pulsed laser source, said control is configured for varying at least one of power of said tunable laser source, frequency of said tunable laser source, and/or speed of said means for moving said target layer relative to said focus of said pulsed laser source based on at least one parameter from said image analyzing program.

17. The pattern generator according to claim 16, wherein:
said HSQ is arranged onto a substrate, and
said pattern generator is configured to vary a patterning distance to a surface of said substrate by at least one of:
varying a focal point of said pulsed laser source by means of a variable focal-length lens assembly, or
varying a height position of said substrate relative to said focal point.

18. The pattern generator according to claim 16, wherein said control unit is configured for varying a polarization of a laser beam from said tunable pulsed laser source based on at least one parameter from said image analyzing program.

19. A device having a shell having one morphology of exposed HSQ encapsulating a core of another morphology of non-exposed HSQ, wherein the exposed volume is within 1-1000 μm³.

20. The device according to claim 19, wherein the exposed volume fully encloses the non-exposed volume, in which the non-exposed volume after baking becomes at least one of photoluminescent or electroluminescent.
